(19) United States
(12) Patent Application Publication
(10) Pub. No.: US 2021/0074450 A1
(43) Pub. Date: Mar. 11, 2021

(54) MAGNETIC ORGANIZING SYSTEM FOR ELECTRICAL CABLES, AND METHOD OF USE

(71) Applicant: Charles Edward Harris, SR., Anacortes, WA (US)

(72) Inventor: Charles Edward Harris, SR., Anacortes, WA (US)

(21) Appl. No.: 17/016,324

(22) Filed: Sep. 9, 2020

Related U.S. Application Data
(60) Provisional application No. 62/897,857, filed on Sep. 9, 2019.
(60) Provisional application No. 63/016,713, filed on Apr. 28, 2020.

(51) Int. Cl. H01B 7/40; H01R 31/06

(52) U.S. Cl. CPC H01B 7/40; H01R 31/06

(57) ABSTRACT

A connector cable is provided, and includes an electrical cord with an electrical connector at each end. The cable includes a plurality of annular magnets positioned on the cord and a spacing sleeve positioned between each adjacent pair of magnets. The magnets are polarized radially, and are configured to rotate freely on the cord, so that when the cable is coiled, the attract and couple with each other, rotating on the cord to bring their poles into appropriate alignment. the spacing sleeves maintain a regular spacing between the magnets so that they couple together in a neat coil.

### CROSS-REFERENCE TO RELATED APPLICATION

This application claims the benefit under 35 U.S.C. § 119(e) of U.S. Provisional Patent Application No. 62/897,857, filed Sep. 9, 2019, and U.S. Provisional Patent Application No. 63/016,713, filed Apr. 28, 2020, which provisional applications are incorporated herein by reference in their entireties.

### BACKGROUND

### Field of the Invention

The present invention relates generally to systems for organizing cables, and, more particularly, to systems employing magnets for same.

### Related Art

Electrical connector cables of various types are ubiquitous in modern society. Particularly with respect to portable electronics, there are several types of cables that are commonly used, including data transmission cables, power charging cables, and headphone cables. In some cases, cables are compatible with multiple devices, so one cable will serve several devices. In other cases, proprietary connectors are used. In any event, many users have four, five, six, or more cables of various types within arm's reach at most times.

### BRIEF DESCRIPTION OF THE DRAWINGS

FIG. 1 is a perspective view of an electrical connector cable, according to an embodiment.

FIG. 2 is a detail view of a portion of the electrical connector cable of FIG. 1, according to an embodiment.

FIGS. 3-8 are diagrammatic views of examples of various coupling magnets for use with the cable of FIG. 1, according to respective embodiments.

FIGS. 9A-9E are perspective views of the electrical connector cable of FIG. 1 in respective stowed configurations.

FIG. 10 is a side diagrammatic view of a portion of an electrical connector cable according to another embodiment.

FIG. 11 is a diagram showing a connector magnetically attached for storage adjacent to a power outlet, according to an embodiment.

FIGS. 12-14 are perspective views of parking brackets, configured to support a portion of a connector cable, held in position by a coupling magnet, according to respective embodiments.

FIGS. 15-17 are cross-sectional views showing details of electrical connector cables in accordance with respective embodiments.

### DETAILED DESCRIPTION

In the drawings, some elements are designated with a reference number followed by a letter, e.g., “108a, 108b.” In such cases, the letter designation is used where it may be useful in the corresponding description to refer to or differentiate between specific ones of a number of otherwise similar or identical elements. Where the description omits the letter from a reference, and refers to such elements by number only, this can be understood as a general reference to the elements identified by that reference number, unless other distinguishing language is used.

While terms such as cable, cord, wire, lead, etc. are considered to be synonymous, or at least to have overlapping definitions, they are used herein to refer to different elements of the disclosed embodiments in order to reduce the likelihood of confusion. Except where such terms are specifically and separately defined, the use of one or another of the terms is not intended to impart a meaning that is distinct from other such terms. Any distinction between the elements is defined by the description of the respective elements. Where such terms are used in the claims, the terms are not limited by their separate meanings as used in the description, but only by the context in which they are used and by any further defining language in the claims.

The term longitudinal, when used with reference to a cable, wire, etc., or an element coupled to a cable, is used to refer to a direction along the length of the cable, lateral and transverse refer to a direction orthogonal to a longitudinal direction.

Many different types of electrical cables are in common use in connection with various electronic devices. For example, many portable electronic devices require regular charging periods, during which the device is connected to a power supply via a charging cable. A user may therefore be obliged to carry a charging cable, or keep one in an automobile, etc., to permit charging when necessary. A common problem with electrical cables of various types, including charging cables, data transmission cables, headphones, etc., is their tendency to become entangled while in storage and between uses. Most users are quite familiar with the need to disentangle a power cable or a headphone cable from a seeming rat's nest of cords or general paraphernalia that tends to gather in small storage spaces. The inventor believes that most known solutions to the problem are inadequate.

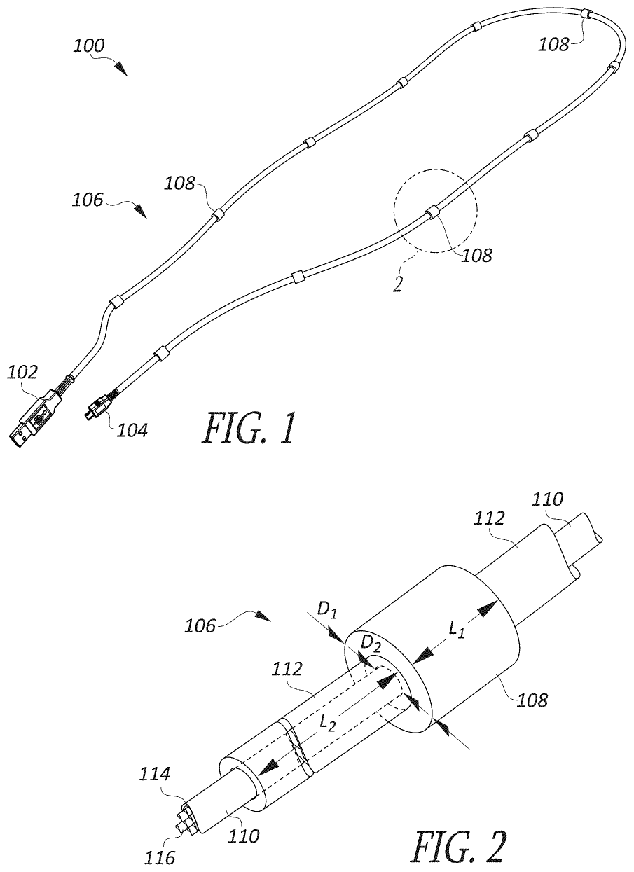

FIG. 1 is a perspective view of an electrical connector cable 100, according to an embodiment. In the example shown, the connector cable 100 is configured as a USB-type cable, with a standard USB connector 102 at a first end and a mini USB connector 104 at a second end. Such connector cables are commonly used as charging cables for many portable electronic devices, as well as transmission cables for transmitting data between electronic devices. Other embodiments include various other types of cables, such as audio and headphone cables, power cables, and connector and charging cables with connectors that are different from those shown, at one or both ends. Accordingly, unless otherwise specified, the claims are not limited to a particular type of cable.

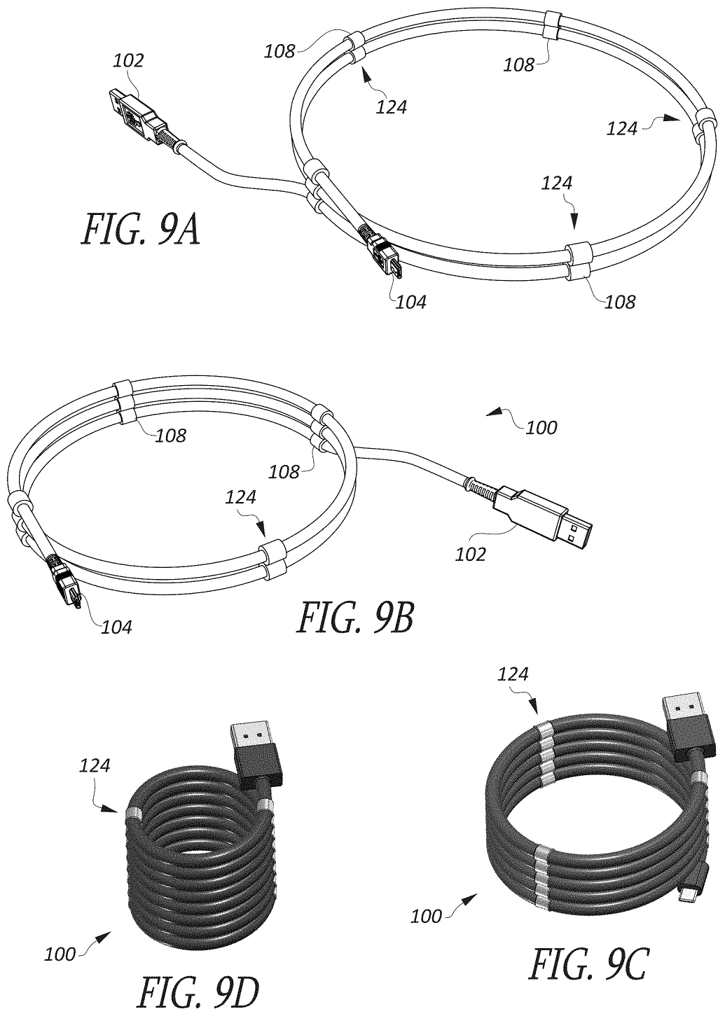

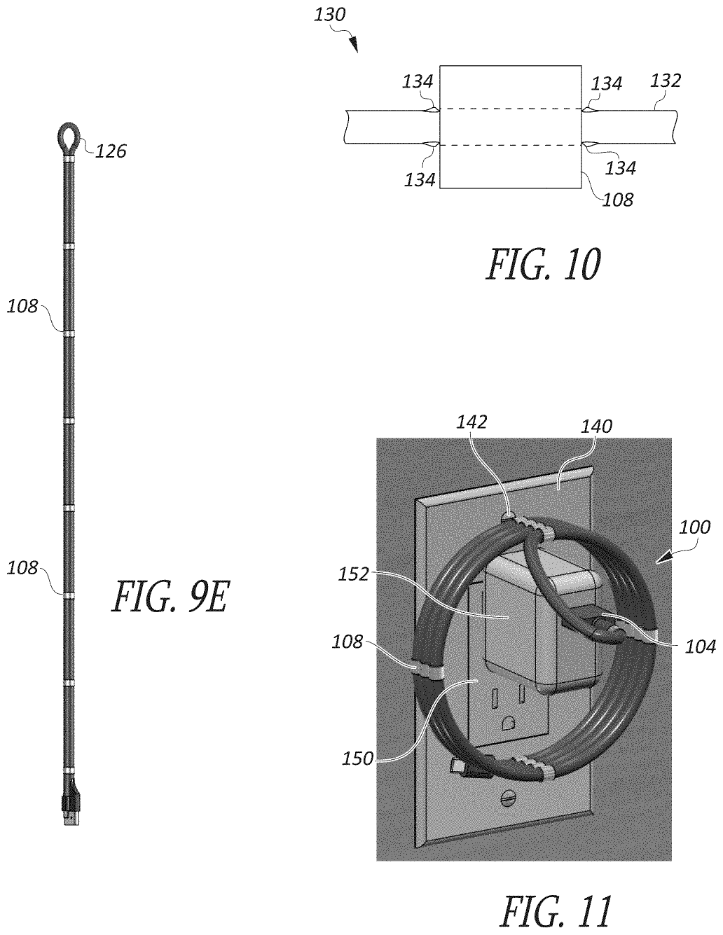

The connector cable 100 includes a cord 106 extending between the connectors 102, 104, with a plurality of coupling magnets 108 positioned at intervals along the length of the cord 106. When the connector cable 100 is coiled for storage, magnets 108 along the length of the cord 106 couple together and, with minimal guidance by the user, organize the cable so that it is held in a neat and compact arrangement. This process is described in more detail below with reference to FIGS. 9A-9D.

FIG. 2 is a view of a portion of the electrical connector cable 100, indicated at 2 in FIG. 1, provided to show additional detail of the electrical connector cable, according to an embodiment. In addition to the plurality of coupling magnets 108, the cord 106 includes a connector wire 110 and a plurality of spacer sleeves 112, each extending between a respective pair of the coupling magnets 108. The connector wire 110 is made according to conventional methods, and includes an insulating sheath 114 that encloses one or more electrically conductive leads 116 that are configured to place the connector 102 or terminals within the connector 102 in electrical contact with the connector 104 or corresponding terminals therein. In embodiments that include more than one lead 116, the conductive leads are typically insulated from each other. The leads 116 are arranged within the insulating sheath 114 as appropriate for the particular application. For example, the leads 116 can be in a single bundle, as shown in FIG. 2, while in other types of cables the leads may be arranged in other configurations, such as coaxial, twisted pairs, etc., such as are well known in the art.

The insulating sheath 114 can be made from any appropriate thermoplastic or thermosetting plastic. For example, thermoplastic materials commonly used for insulation on connector wires include PVC (polyvinyl chloride), PE (polyethylene), ECTFE (ethylene chlorotrifluoroethylene), PVDF (polyvinylidene difluoride), Nylon etc., while commonly used thermosetting plastics include XLPE (high-density crosslinked polyethylene), CPE (chlorinated polyethylene), and EPR (ethylene propylene rubber), etc.

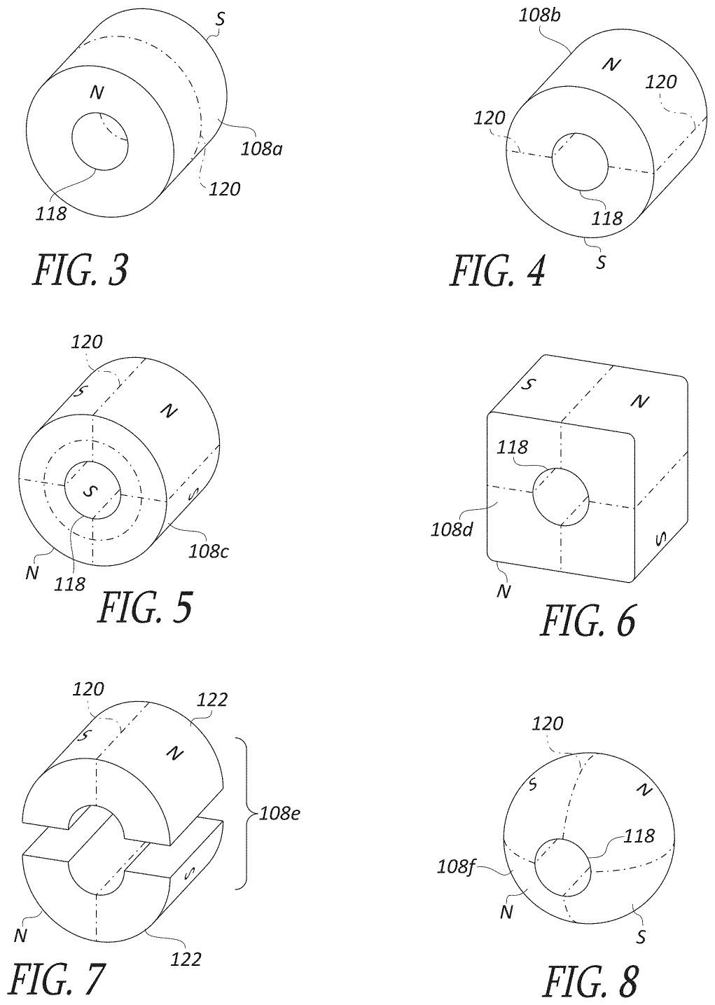

The magnet 108 of FIG. 2 is representative of each of the plurality of magnets 108 of the connector cable 100. According to an embodiment, the connector magnets 108 are cylindrical in shape, with a central through-hole, or aperture 118 extending through each magnet, generally concentrically with an outer diameter (see, e.g., FIGS. 3-5). The size of the magnets 108 is selected such that the connector wire 110 can pass through the central apertures 118. According to the embodiment shown, the connector wire 110 has a nominal diameter of about 0.125 inch (about 3 mm), the outer diameter D₁ of the magnets 108 is about 0.25 inch (about 6 mm), the central apertures 118 have a diameter D₂ of about 0.125 inch (about 3 mm), and the magnets each have a length L₁ of about 0.25 inch (about 6 mm). Each of the spacer sleeves 112 has a length L₂ of about 2.5 inches (about 6.35 cm), which establishes an approximate spacing between the coupling magnets 108. Other embodiments are also contemplated, in which the dimensions of the wire and/or coupling magnets vary, and in which the spacing is more or less than this value, or in which the spacing varies along the length of the wire.

According to one embodiment, the spacing is selected so as to maintain the cable 100 in a neat and organized fashion, and to prevent entanglement. An appropriate spacing can depend, in part, on the relative flexibility of the cable. This, in turn, can depend in part on the diameter and/or material of the cable. Cable with a larger diameter may tend to be stiffer than a smaller diameter cable, and therefore not require as many magnets along its length. Of course, there is a great deal of leeway in what would be regarded as an appropriate spacing, which is also subject to other design considerations.

According to one embodiment, the magnets 108 are affixed to the connector wire 110 at intervals along its length. According to another embodiment, the magnets 108 are not affixed, but are able to slide or rotate on the connector wire 110. The spacer sleeves 112 are sections of tubing material that are interleaved with the plurality of coupling magnets 108 on the connector wire 110, and serve to maintain a selected interval between each of the coupling magnets, particularly in embodiments in which the magnets are not affixed to the connector wire. The spacer sleeves 112 have an inside diameter that is equal to or slightly greater than the outside diameter of the connector wire 110, so as to be able to slide over the wire 110 during assembly, and to move slightly during use, to minimize interference with rotation of the coupling magnets 108. The outside diameter of the spacer sleeves 112 is greater than the inside diameter of the central apertures 118 of the coupling magnets 108, which prevents the magnets from sliding over the sleeves, so that the spacing between the magnets is controlled by the spacer sleeves 112. The spacer sleeves 112 can be made of any appropriate materials, including the same types of materials commonly used for the insulating sheath, as described above. According to another embodiment, the spacer sleeves 112 are made from an elastomeric material, such as, for example, silicone, natural or synthetic rubber, polyurethane, EPR, etc. The elastomeric material provides some resiliency to permit minor adjustments, longitudinally, to the positions of the magnets, and may also provide some additional protection to the connector wire 110 and/or the coupling magnets 108 from crushing impacts, etc.

In addition to various advantages and benefits provided to the user by the use of elastomeric material in the spacer sleeves 112, the elastomeric material can also be advantageous during the manufacture of the connector cable 100. Typically, during the manufacturing process of a connector cable, a worker inserts first one end and then the opposite end of the connector wire 110 into a machine that forms the connectors 102, 104 on respective ends of the cord. According to an embodiment, after forming a first one of the connectors 102, 104 on the connector wire 110, a plurality of coupling magnets 108 and a plurality of spacer sleeves 112 are introduced onto the wire, such that each adjacent pair of magnets is separated by a spacer sleeve. The other of the connectors 102, 104 is then formed on the opposite end of the connector wire 110, thereby trapping the magnets 108 and spacer sleeves 112 on the wire.

Inasmuch as, in many embodiments, the lengths of the spacer sleeves 112 are selected such that a sum of the lengths of the spacer sleeves 112 and the magnets 108 is approximately equal to the length of the connector wire 110 between the connectors 102, 104, there is a potential for interference of a coupling magnet and/or a spacer sleeve with the operation of the machine that forms the connector. However, during the process of forming the second of the connectors 102, 104 on the connector wire 110, the worker grasps the spacer sleeve 112 or connector 102, 104 closest to the end of the connector wire 110 on which the connector is to be formed and pulls toward the opposite end of the wire. The connector that is already formed at the opposite end prevents the sleeves 112 and magnets 108 from sliding off the wire; instead, the elastomeric material of the spacer sleeves is compressed in the longitudinal dimension, permitting the worker to expose a few inches of the wire so that the second connector can be formed without interference from magnets or sleeves, and without requiring special tooling to accommodate the nonstandard cable arrangement.

FIGS. 3-8 are diagrammatic views of examples of various coupling magnets 108 that can be used with the cable 100 of FIG. 1, according to respective embodiments. The polarity of the magnet 108a of FIG. 3 is axially oriented, with north and south poles arranged longitudinally, relative to a central axis of the cylindrical magnet. Thus, a nominal transition region 120 between the poles is transverse to the central axis. In contrast, the polarity of the magnet 108b of FIG. 4 is radially oriented, with north and south poles arranged laterally, relative to the central axis, so that the transition region 120 between the poles extends parallel to the central axis. Both of these configurations are commercially available. The configuration of the magnet 108a of FIG. 3, is typically the stronger of the two types, but the configuration of the magnet 108b has some surprising advantages, as will be described below with reference to FIGS. 9A-9E.

The coupling magnets 108a and 108b, of FIGS. 3 and 4, are dipole magnets, each having a single north pole and a single south pole. The coupling magnet 108c of FIG. 5 is a radially oriented “quadrupole” magnet, with, effectively, four magnets arranged radially around the central axis, and formed into a single body. The coupling magnet 108c has two north and two south poles alternating around its circumference, and two more of each pole alternating around the inside of the central aperture 118. For the purposes of this disclosure, the poles within the aperture 118 can be ignored. The magnet 108c, and similarly configured magnets, can be considered to have four alternating poles, substantially as illustrated with reference to FIGS. 6-8. Furthermore, while dipole and quadrupole magnets are disclosed herein, by way of examples, magnets with other numbers of poles are available and can be used, to the extent appropriate.

In addition to different numbers and arrangements of magnetic poles, embodiments are contemplated in which the coupling magnets 108 have different shapes, as shown in the examples of FIGS. 6-8. FIG. 6 shows a radially oriented, cubic-shaped quadrupole coupling magnet 108d, according to another embodiment. Other embodiments include dipole versions.

FIG. 7 shows a coupling magnet 108e formed of two magnet segments 122 that together form a quadrupole magnet that is functionally similar to the magnet 108c of FIG. 5. The magnetic poles of the magnet segments 122 are arranged so that their normal mutual attraction couples them strongly together around the wire 110. Additionally, according to another embodiment, a casing or housing is provided, that couples, with a snap-fit closure, for example, around the magnets to prevent the magnets from separating. Alternatively, the magnet segments 122 are bonded together, such as by an adhesive or cement, around the wire 110, in a manner that firmly couples the segments together without interfering with rotation of the coupling magnet 108e on the wire. According to another embodiment, the magnet segments 122 are each a dipole magnet configured such that when joined, they form a dipole magnet similar to the coupling magnet 108b of FIG. 4. An advantage provided by the coupling magnet 108e is that it can be installed onto a connector cable after the connectors have been attached at each end, rather than before the manufacturing process of the cable is complete.

According to a related embodiment, a coupling magnet comprises a number of smaller magnet segments, such as, e.g., four, six, or eight segments. A casing is configured to snap closed over the wire 110 and to rotate freely about the wire. The casing is provided with a plurality of sockets or spaces, each configured to receive a respective one of the magnet segments before the casing is closed. According to an embodiment, the small magnet segments are cylindrical magnets with north and south poles at opposite ends of the magnets. According to another embodiment, the magnet segments are square or rectangular in transverse section, with north and south poles extending longitudinally on opposing faces.

The magnets are arranged in the casing in alternating polarities, so that when two such coupling magnets are brought into close proximity, one or both of the magnets can rotate slightly to bring magnet segments with opposite polarities or orientations into a facing relationship with each other, in a manner similar to that described below with reference to FIGS. 9A-9E.

FIG. 8 shows a spherically shaped coupling magnet 108f, according to an embodiment. The coupling magnet 108f is shown in FIG. 8 as being a quadrupole magnet. According to another embodiment, the magnet 108f is a dipole-type magnet.

Magnets can be manufactured using many different processes. Some processes, including, e.g., metal injection molding and sintering, enable a very wide range of magnet shapes. Selection of the shape of the coupling magnets 108 is a design consideration and can be made in view of various factors. For example, the surface area over which magnets contact each other influences the strength with which the magnets adhere. Thus, magnets with flat sides, like the cube-shaped coupling magnets 108d of FIG. 6, will make contact over a relatively large area, and so will have a relatively strong bond. Cylindrical magnets, like those shown in FIGS. 3, 4, 5, and 7, make contact only along a longitudinal line, and so will have a bond that is not as strong as the magnet of FIG. 6. Spherically shaped magnets, like the coupling magnet 108f, of FIG. 8, make contact over the smallest area, with a correspondingly weak bond. Any of these characteristics may be preferable, under different circumstances.

A designer can of course select the shape of the connector magnets on the basis of preference or other reasons not directly connected with the function of the device. For example, according to an embodiment, a shape is selected that corresponds to a company trademark, as a promotional tool.

FIGS. 9A-9E are perspective views of the electrical connector cable 100 of FIG. 1 in respective coiled or stowed configurations. When the connector cable 100 is coiled, the magnets 108 seek out and engage each other so that, with a minimum of guidance by the user, they form the cable into a neat coil. The magnets 108 form themselves into stacks, or nodes 124 holding the coils in position. FIG. 9A shows the connector cable 100 in a coil with five nodes 124 of magnets 108, while FIG. 9B shows the connector cable in a coil with four nodes. This produces a smaller coil, with more loops than the coil of FIG. 9A. Coils with larger or smaller numbers of nodes 124 than shown can also be formed.

The inventor has found that radially oriented coupling magnets provide some surprising and useful advantages over the use of magnets with the more conventional axial orientation. Referring first to the axially oriented coupling magnet 108a of FIG. 3, a logical arrangement is to alternate the orientation of each magnet along the wire, so that each magnet is oriented opposite the orientation of the adjacent magnet(s). Because the magnetic poles are at the ends of the magnets, their angular orientation about the central axis of the connector wire 110 is not a consideration. Thus, while the coupling magnets 108a can be positioned on the wire 110 with spacer sleeves interleaved, as described above, alternatively, the magnets 108a can be affixed to the connector wire 110 at the selected interval, with adhesive, friction fit, or some other method. This obviates the need for the spacer sleeves 112.

However, when used with axially-oriented coupling magnets such as the magnet 108a of FIG. 3, a surprising limitation is introduced, i.e. When the connector cable 100 is coiled with an odd number of nodes 124, such as five, as shown in FIG. 9A, each magnet 108a aligns next to a magnet with an opposite polarity, the north and south poles of one magnet coupling magnetically with the south and north poles, respectively, of the next magnet in a strong connection at each node. However, if the user were to attempt to form the connector cable 100 into a coil with an even number of nodes 124, such as four, as shown in FIG. 9B, this would place each magnet 108a alongside a magnet with the same orientation, with north poles together and south poles together. Of course, the magnets themselves will resist such an arrangement. The coil could be made slightly smaller or slightly larger, so that the front of one magnet 108a is adjacent to the back of a neighboring magnet, but this would only join portions of one end of each magnet, resulting in a weaker and less stable arrangement. This would also permit magnets 108a to rotate with respect to others in a same node, with an increased likelihood of entanglement. From a practical point of view, a coil using the magnets 108a of FIG. 3 is limited to coils with odd numbers of nodes 124.

In contrast, a connector cable 100 with radially oriented coupling magnets, such as those shown in FIGS. 4-8, can be coiled with any number of nodes 124. As the user lays each loop of the cable 100 over the previous loop, each magnet rotates about its longitudinal axis on the connector wire 110 to align its opposite pole with the uppermost pole of the adjacent magnet. Because the magnets 108b are not affixed to the wire 110, they are free to rotate into alignment, regardless of the orientation of the magnets that are adjacent, either in the stack of magnets of a node, or on the cable. Whether the magnets are dipole, like the coupling magnet 108b of FIG. 4, or quadrupole magnets, like the coupling magnets 108c-108f of FIGS. 5-8, their behavior is similar, except that a dipole magnet might rotate as far as 180 degrees, while a quadrupole magnet would need to rotate no more than 90 degrees to align with an adjacent magnet. Radially oriented coupling magnets with larger numbers of poles have a similar operation, but require even less rotation to align with each other in a node.

FIGS. 9C and 9D show the connector cable 100 coiled into tighter coils of three and two nodes, respectively. FIG. 9E shows the cable 100 folded in the center, with the coupling magnets 108 holding the ends firmly together, so that a loop 126 is formed in the cable. This configuration is useful if a user wishes to hang the cable over a hook or peg, etc. The coupling of the magnets 108 keeps the cable secure and compact.

According to an embodiment, means for reducing friction between the coupling magnets 108 and the wire 110 and/or between the magnets and the spacer sleeves 112 is provided, such as, for example, roller bearings, washers, bushings, or sleeves positioned between the wire and each of the coupling magnets, and/or sleeves, etc.

Various embodiments are contemplated in which the bonding strength of the coupling magnets 108 varies along the cable 100. For example, according to an embodiment, the two or three coupling magnets 108 closest to the connector 104 at the second end of the cable 100 are weaker, magnetically, than the remaining magnets. Accordingly, when the cable 100 is coiled as described above, and only a short length of cable is required, when a user pulls on the connector 104, the first two or three coupling magnets 108 release from their respective nodes 124 before any of the other magnets, so that most of the coil remains intact, without thought or effort on the part of the user. According to another embodiment, the bonding strength of the coupling magnets 108 varies progressively along the length of the cable 100 so that as the user pulls on the connector 104, each magnet releases in order along the entire length.

The bonding strength can be varied by varying the magnetic strength of the respective magnets 108, or by using magnets of different shapes. As noted above, the bonding strength of the cube-shaped coupling magnet 108D is greater than that of the cylindrical magnets 108b, 108c, 108d of FIG. 4, 5, or 7, which in turn is greater than that of the spherical magnet 108f of FIG. 8. Thus, by using magnets of different shapes along the cable, the effective bonding strengths can be varied.

The connector cable 100 of FIGS. 9A and 9B has a slightly differently configuration from that of FIGS. 9C-9E. In particular, the cable 100 of FIGS. 9A and 9B includes eleven coupling magnets 108, and is arranged so that the connector wire 110 extends farther beyond the last coupling magnet at one end of the cable than at the other. This provides a short length of cable that the user can connect to a cell phone or other device for charging, for example, while the remaining length of the cable can lie in a coil. In contrast, the cable 100 of FIGS. 9C-9E includes fifteen coupling magnets 108, and the magnets closest to each end of the cable are adjacent to the respective one of the connectors 102, 104. Variations such as the length of the cable, the spacing and positioning of the coupling magnets, etc., are design considerations that can be selected to accommodate particular choices or requirements of an intended application.

FIG. 10 is a side diagrammatic view of a portion of an electrical connector cable 130 according to another embodiment. The connector cable 130 is similar in most respects to the cable 100 previously described, except that the spacer sleeves 112 are omitted. Additionally, the connector cable 130 includes a wire 132 on which detent bumps 134 are provided. According to an embodiment, a set of detent bumps, i.e., one or more detent bumps 134 are distributed around the wire 132 in a first position along the length of the wire, with another set of detent bumps separated longitudinally from the first set by a distance that is equal to or, preferably, slightly greater than the length of the magnet 108. The detent bumps 134 are sized such that they can, with some resistance, be passed through the central aperture 118 of the magnet 108, but spaced to permit the magnet to rotate freely while positioned between adjacent sets of bumps. Thus, the magnets 108 can be slid onto the wire 132 and positioned between adjacent sets of detent bumps 134 during assembly, but the detent bumps resist longitudinal movement of the magnets 108 once the magnets are positioned on the wire 132.

The detent bumps 134 can be formed on the connector wire 132 by any appropriate process. For example, according to one embodiment, the detent bumps 134 are formed during the manufacturing process of the wire. According to another embodiment, the insulating sheath 114 of the connector wire 132 is a thermoplastic material, as previously described. The bumps 134 are formed on the wire 132 by a set of heated dies that pinch or otherwise deform the wire at regular intervals, softening and raising small portions of the insulating sheath 114. These portions remain as the detent bumps 134 when the material cools. According to another embodiment, small amounts or drops of a compatible material are deposited on the wire 132 at selected locations, which bond with the material of the insulating sheath 114 to form the detent bumps 134. The term compatible is used here to refer to a material that is capable of forming a substantially permanent bond with the material of the insulating sheath 114. Embodiments are envisioned in which this material forms a chemical bond or a strong adhesive bond with the material of the insulating sheath 114, and, furthermore, can be configured to be, for example, a thermoplastic or thermosetting polymer.

According to an alternate embodiment, each of the plurality of coupling magnets on the wire 132 comprises multiple magnet segments, as described above, for example, with reference to FIG. 7. After formation of the detent bumps 134 on the wire 132, the segments are coupled together around the wire and between the detent bumps. Retainer clips may then be attached, in those embodiments that employ retainer clips, to secure the segments. One benefit of the alternate embodiment is that it is not necessary to install the coupling magnets before both of the connectors 102, 104 are attached to the wire 132, nor that the detent bumps be sized to permit passage of the magnets during installation. Instead, the detent bumps 134 can be formed, and the coupling magnets 108 installed onto the wire 132 of a premanufactured connector cable.

According to a further embodiment, stops are positioned on the wire to constrain longitudinal movement of the coupling magnets. These can be, for example, tight rubber rings, similar to O-rings, that do not move easily on the wire, but can be positioned on either side of each coupling magnet. According to an embodiment, the stops are sufficiently resilient as to stretch over one of the connectors on the cable, so they can be installed on a premanufactured cable.

FIG. 11 is a diagram showing a connector cable 100 as it can be stored, ready for use, according to an embodiment. The cable 100 is in a coil with one of the nodes 124 coupled to a mounting screw 142 of a cover plate 140 of a power socket 150, with the connector 104 coupled to the output terminal of a power supply 152 that is plugged into the power socket. In order to charge a cell phone, for example, the user can pull from the coil just enough of the power cord 100 to reach the phone, keeping the rest of the cord neatly coiled and out of the way.

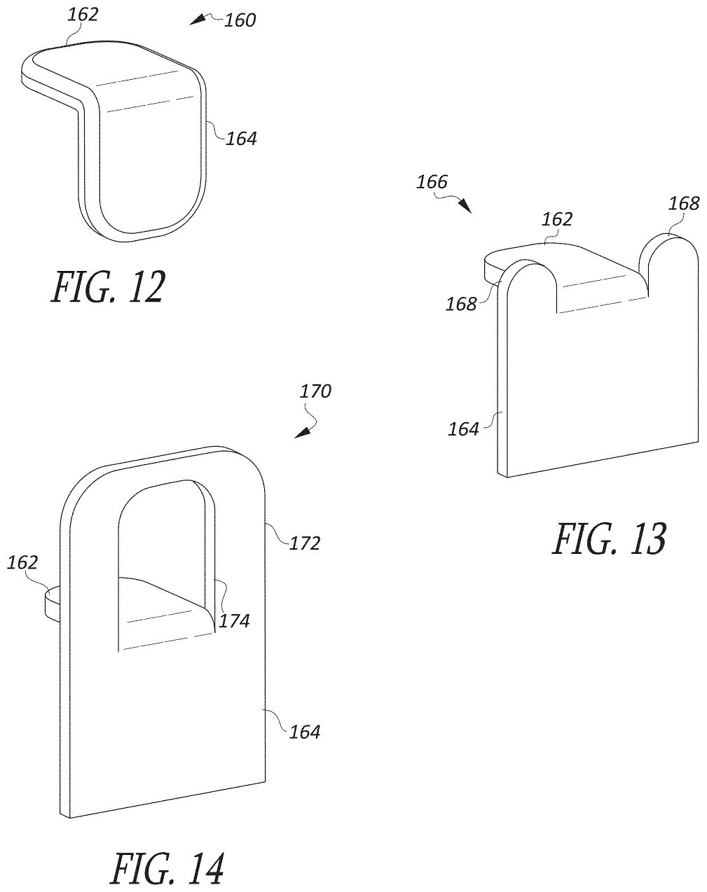

FIGS. 12-14 are perspective views of parking brackets configured to support an end of a connector cable that is held in position by a coupling magnet, according to respective embodiments. FIG. 12 shows a parking bracket 160 that is made from ferromagnetic sheet metal that is bent to form a right angle, with a horizontal tab 162 and a vertical tab 164. In a case, for example, in which a desk is positioned against a wall with a power outlet in the wall behind the desk, the parking bracket 160 can be attached to the back edge of the desk, with the horizontal tab 162 resting on, or affixed to the desktop and the vertical tab 164 extending over the edge of the desk. The parking bracket 160 can be attached by any appropriate means, including, e.g., double-sided adhesive tape, glue, mechanical fasteners, etc. A connector cable, configured according to an embodiment described above and coupled at one end to the power outlet, is positioned with the other end extending from behind the desk and positioned so that the last one of the coupling magnets is magnetically attached to the parking bracket 160. In this way, the free end of the connector cable is held out of the way, but within easy reach of an occupant of the desk. According to an embodiment, tabs of double-sided adhesive material a pre-applied to the parking bracket 160 during the manufacturing process. The end user therefore only needs to remove the protective liner from the adhesive material and press the bracket into place.

FIG. 13 shows a parking bracket 166 that is similar to the bracket 160 of FIG. 12, except that it also includes a pair of ears 168 that extend upward from the vertical tab, on either side of the horizontal tab. The operation of the parking bracket 166 is substantially similar to that of the bracket 160, but the ears 168 provide some additional control, by guiding the connector cable as the user pulls a portion of the cable from behind the desk, etc.

FIG. 14 shows a parking bracket 170 that differs from the brackets 160 and 166 of FIGS. 12 and 13 in that it includes an extension 172 of the vertical tab 164 with a guide aperture 174 adjacent to the horizontal tab 162. The guide aperture 174 provides increased security for the connector cable. For example, it is common, with conventional connector cables, for a user to inadvertently release a cable such that it falls behind a desk or table. While the brackets 160 and 166 will securely hold the end of a connector cable, a user will generally need to make sure, first, that the cable is positioned so that one of the coupling magnets can engage the bracket. However, in the case of the parking bracket 170, the cable is preferable positioned so that it extends through the guide aperture 174. A user pulls a desired length of the cable through the aperture, from behind the desk. When released, the cable will not slide back behind the desk, but will be coupled to the parking bracket 170 by the closest coupling magnet.

According to another embodiment, a user coils a desired length of the connector cable, as described above with reference to FIGS. 9A-9D, and couples the coiled cable to a parking bracket, with the balance of the cable extending behind the desk. Thus, the desired length is always held close at hand without contributing to clutter and confusion.

The coupling magnets described above can be made from any appropriate ferromagnetic material, using processes that are well known in the industry. In addition, magnets made from other materials—such as resins and polymers in which particles of ferromagnetic material are encapsulated—are also well known in the art and can be used to make the coupling magnets. The inventors have made prototypes using neodymium magnets, which have been very effective in performing as described above. However, the inventors have found that such material can be relatively brittle, and that there is some danger of breakage of the magnets during hard use. Accordingly, various embodiments are contemplated in which the coupling magnets are protected from breakage.

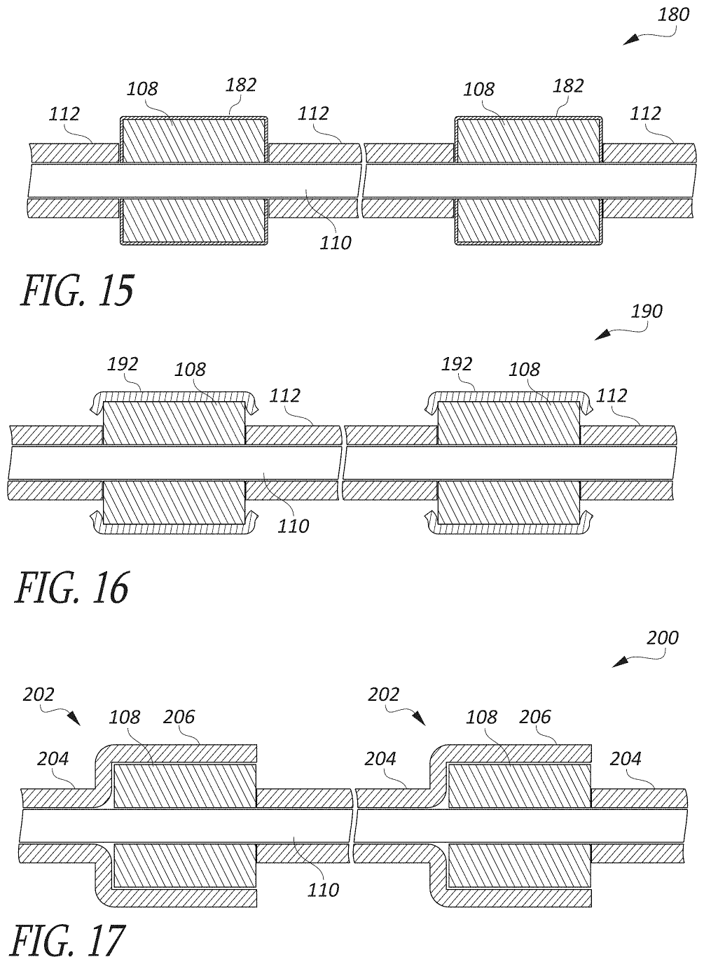

FIGS. 15-17 are cross-sectional views showing details of electrical connector cables in accordance with respective embodiments. FIG. 15 is a partial sectional view of an electrical connector cable 180 showing a representative adjacent pair of coupling magnets 108 on the connector wire 110, according to an embodiment. As with previous embodiments, the cable 180 includes a connector wire 110 and a plurality of coupling magnets 108 spaced apart by spacer sleeves 112. However, in addition, the coupling magnets 108 are at least partially encapsulated within a protective coating 182 that is configured to reduce or prevent breakage.

According to an embodiment, the coating 182 is a tough resin material, such as, e.g., epoxy or another polymer, etc. The coating 182 provides some impact protection for the magnets 108. Additionally, in the event that a magnet 108 does fracture, the coating 182 can be configured to retain the pieces of the magnet in position, so that they can continue to function as described. The material of the coating 182 can be applied to the coupling magnets 108 in any appropriate manner, including, for example, spray processes, dipping process, over-molding processes, etc.

FIG. 16 is a partial sectional view of an electrical connector cable 190, according to another embodiment. In the embodiment of FIG. 16, each of the magnets 108 is encased within a sheath or sheath segment 192 of an elastomeric material, which is configured to resiliently cushion impacts, so as to reduce or eliminate the likelihood of breakage. The elastomeric material sheaths 192 can be applied as a coating on the magnets 108, which is applied as described above and cured in place, or, as shown in FIG. 16, as sheath segments into which the magnets 108 are inserted. According to an embodiment, elastomeric sheath segments 192 are longer than the coupling magnets 108 but have an inside diameter that is smaller than the outside diameter of the magnets. When a magnet 108 is introduced into a sheath segment 192, the elastomeric material stretches to accommodate the larger diameter, while the ends of the segment, which extend beyond the ends of the magnet, draw back to a smaller diameter, thereby securely capturing the magnets.

According to another embodiment, protective plastic sheath segments are provided that are configured to snap into place over the coupling magnets 108 and protect them from impact damage. According to an embodiment, the sheath segments also serve as casings configured to hold multiple magnet segments, as described above, for example, with reference to FIG. 7.

FIG. 17 is a partial sectional view of an electrical connector cable 200, according to another embodiment. The cable 200 includes a connector wire 110 and a plurality of coupling magnets 108. The magnets 108 are spaced apart by spacer sleeves 202 which also at least partially enclose the magnets. Each of the spacer sleeves 202 includes a spacing section 204 and an enclosure section 206. Each of the spacing sections 204 is sized to fit over the connector wire 110, while the enclosure section 206 is sized to fit over a corresponding coupling magnet 108. The inside diameter of the spacing sections 204 is selected to be slightly greater than the outside diameter of the wire 110. This enables the spacer sleeves 202 to rotate with the magnets 108 around the wire during use.

The length of each of the spacing sections 204 is selected to provide a regular spacing of the coupling magnets 108 along the length of the wire 110. According to an embodiment, each of the spacer sleeves 202 is identically sized, with a first one of the coupling magnets 108 being positioned close to a first end of the connector cable 200, while the last one of the magnets is spaced away from the opposite end of the cable by at least the length of the spacing section 204. This is advantageous in some applications, as it will leave that end of the cable loose and accessible, as described above with reference to FIGS. 9A and 9B. In fact, in some cases, it may be desirable to provide a relatively long portion of the cable that is free of magnets. Therefore, an embodiment is contemplated in which the last of the spacer sleeves 202 includes a spacing section 204 that is significantly longer than the spacing sections of the remaining sleeves. Alternatively, additional spacer sleeves can be positioned at one end of the cable without magnets between them, in order to provide a nonmagnetic length.

Of course, in other cases, it will be desirable to have coupling magnets 108 positioned close to both ends of the cable 200. An embodiment is therefore contemplated in which the last spacer sleeve 202 on the cable 200 does not include a spacing section 204, or in which the spacing section is much shorter than the spacing sections of the remaining spacer sleeves.

According to an embodiment, each of the spacer sleeves 202 is a segment of elastomeric tubing that is stretched to enclose and resiliently hold a respective one of the coupling magnets 108, so that the enclosure section 206 is formed when the magnet is introduced therein. According to another embodiment, the spacer sleeves 202 are preformed, with enclosure sections 206 sized to receive the magnets 108 therein.

Although shown in FIG. 17 with coupling magnets 108 positioned in respective enclosure sections 206 at an end of the respective spacer sleeves 202, the magnets can be positioned anywhere within the spacer sleeves, including at the center, or extending partially from an end of the sleeves. In such embodiments, the spacing between each adjacent pair of coupling magnets 108 is of course controlled by the portions of the two spacer sleeves 202 that lie between the respective pairs of magnets. Nevertheless, as with other embodiments, the spacing of the magnets 108 on the wire 110 can be described as being controlled or determined by selection of the length of the spacer sleeve 202: It will be recognized that for proper operation, in most cases, the distance between adjacent pairs of coupling magnets 108 should be approximately equal along the length of the cable 200. Thus, with the possible exception of one or both sleeves 202 at the ends of the cable, the lengths of each of the spacer sleeves should also be approximately equal, and each of the coupling magnets 108 should be in the same position within its respective spacer sleeve, so that the magnets will align with others into nodes to form a coil. Thus, the distance between one of the coupling magnets 108 and the coupling magnets on either side will be about equal to the length of the portion of the spacer sleeve 202 extending in one direction along the connector wire 110 plus the length of the portion of the same spacer sleeve extending in other direction along the connector wire, whether each magnet is positioned at one end of the respective sleeve or at some other position within the respective sleeve.

As used herein, the term adjacent pair refers to pairs of coupling magnets that are immediately adjacent to each other on a connector cable. Thus, every magnet is part of at least one adjacent pair, and, except for the first and last magnets on a cable, every magnet is part of two adjacent pairs.

The abstract of the present disclosure is provided as a brief outline of some of the principles of the invention according to one embodiment, but is not intended as a complete or definitive description of any single embodiment thereof, nor should it be relied upon to define terms used in the specification or claims. The abstract does not limit the scope of the claims.

Various embodiments have been described above to illustrate the principles of the invention. However, many other embodiments are contemplated. For example, according to various embodiments, coupling magnets are provided on audio headphone cables, power cords of appliances and electronic devices, etc. It will therefore be understood that the scope of the appended claims should not be limited by particular embodiments set forth herein, but should be construed in a manner consistent with the specification as a whole.

What is claimed is:

1. A connector cable, comprising:
a plurality of magnets, each having an aperture;
an electrical cord, having one or more insulated conductors, extending through the aperture of each of the plurality of magnets;
a plurality of spacing sleeves positioned on the electrical cord such that a spacing of the plurality of magnets on the cord is controlled by a length of each of the plurality of spacing sleeves; and
first and second connectors positioned at respective ends of the electrical cord and electrically coupled to the one or more insulated conductors of the cord.

2. The connector cable of claim 1, wherein each of the plurality of spacing sleeves is sized to rotate freely on the electrical cord.

3. The connector cable of claim 1, wherein the aperture of each of the plurality of magnets is sized such that the respective magnet rotates freely on the electrical cord.

4. The connector cable of claim 1, wherein a polarity of each of the plurality of magnets is oriented radially, relative to a longitudinal axis of the electrical cord.

5. The connector cable of claim 1, wherein the plurality of magnets and the plurality of spacing sleeves are arranged on the electrical cord with a respective one of the plurality of spacing sleeves positioned between each adjacent pair of the plurality of magnets.

6. The connector cable of claim 1, wherein a portion of each of the plurality of spacing sleeves extends over a respective one of the plurality of magnets.

7. The connector cable of claim 1, comprising a protective covering positioned over each of the plurality of magnets.

8. The connector cable of claim 7, wherein the protective covering is a protective coating formed on each of the plurality of magnets.

9. The connector cable of claim 7, wherein the protective covering is a protective sheath positioned over each of the plurality of magnets.

10. The connector of claim 9 wherein the protective sheath comprises segments that couple together over the respective magnet with a snap fit.

11. The connector cable of claim 1, wherein each of the plurality of magnets is a dipole magnet.

12. The connector cable of claim 1, wherein each of the plurality of magnets includes two magnets segments configured to be coupled together over the electrical cord.

13. The connector cable of claim 1, wherein the plurality of spacing sleeves are made of an elastomeric material.

14. The connector cable of claim 1, wherein each of the plurality of spacing sleeves is about equal in length.

15. The connector cable of claim 14, comprising an additional spacing sleeve that has a length that is different from the length of each of the plurality of spacing sleeves.

16. The connector of claim 1, wherein a length of the electrical cord between the first and second connectors is about equal to a sum of the lengths of each of the plurality of magnets and each of the plurality of spacing sleeves.

17. A connector cable, comprising:
a plurality of magnets, each having an aperture;
an electrical cord, having one or more insulated conductors, extending through the aperture of each of the plurality of magnets;
a plurality of spacing sleeves, each having an inner dimension that permits movement of each spacing sleeve relative to the electrical cord, positioned on the electrical cord with a respective one of the plurality of spacing sleeves arranged between each adjacent pair of the plurality of magnets; and
first and second connectors positioned at respective ends of the electrical cord and electrically coupled to the one or more insulated conductors of the cord.

18. The connector cable of claim 17, wherein a distance between each adjacent pair of the plurality of magnets is controlled by a length of the respective one of the plurality of spacing sleeves arranged therebetween.

19. A connector cable, comprising:
a plurality of magnets, each having an aperture;
an electrical cord, including one or more insulated conductors, extending through the aperture of each of the plurality of magnets;
a plurality of elastomeric spacing sleeves interleaved with the plurality of magnets on the electrical cord; and
first and second connectors positioned at respective ends of the electrical cord and electrically coupled to the one or more insulated conductors of the cord.

20. The connector cable of claim 19, wherein a distance between each adjacent pair of the plurality of magnets is defined by a length of a respective one of the plurality of elastomeric spacing sleeves that is positioned between the respective adjacent pair of the plurality of magnets.

21. A connector cable, comprising:
an electrical cord, including one or more insulated conductors
first and second connectors positioned at respective ends of the electrical cord and electrically coupled to the one or more insulated conductors of the cord; and
a plurality of magnets distributed along the electrical cord with the electrical cord passing through an aperture formed in each of the plurality of magnets; and
a set of detent bumps formed on an outer surface of the electrical cord at each end, longitudinally, of each of the plurality of magnets, such that each of the magnets is constrained from substantial longitudinal movement along the wire by a pair of sets of detent bumps.

22. The connector cable of claim 21, wherein the sets of detent bumps are formed from the material of an outer insulating sheath of the electrical cord.

23. The connector cable of claim 21, wherein the sets of detent bumps are formed of a material that is compatible with a material of an outer insulating sheath of the electrical cord.
